(19) United States
(12) Patent Application Publication
(10) Pub. No.: US 2006/0063058 A1
(43) Pub. Date: Mar. 23, 2006

(54) Fuel supplying system for fuel cell and fuel cell employing the same

(76) Inventor: Yasuo Kurachi, Toyokawa-shi (JP)

Correspondence Address: CANTOR COLBURN, LLP, 55 GRIFFIN ROAD SOUTH, BLOOMFIELD, CT, 06002, US

(21) Appl. No.: 11/217,571

(22) Filed: Sep. 1, 2005

(30) Foreign Application Priority Data
Sep. 7, 2004 (JP) JP2004-259432

(51) Int. Cl. H01M 8/04; B65D 90/02

(52) U.S. Cl. 429/34; 220/565

(57) ABSTRACT

A fuel supplying system for a fuel cell, may comprise a container having therein a liquid fuel and a carrier for fixing the liquid fuel, wherein the carrier contains solid particles having an average particle diameter of 0.1 μm to 5 mm.

This application is based on Japanese Patent Application No. 2004-259432 filled on Sep. 7, 2004, in Japanese Patent Office, the entire content of which is hereby incorporated by reference.

### FIELD OF THE INVENTION This invention relates to a fuel supplying system for a fuel cell and a fuel cell employing the fuel.

### BACKGROUND OF THE INVENTION

There are many kinds of fuel cells, among them a direct methanol fuel cell has a trait that electric power can be generated by supplying methanol in a liquid state without any process for taking out hydrogen gas by modifying methanol aqueous solution. Consequently, the direct methanol fuel cell is simple in the structure as the power generation system and easily can be made smaller size and light weight compared to usual solid polymer type fuel cell to which the fuel is supplied after gasification or modification. Therefore, the direct methanol fuel cell is noted as a decentralized power source and a portable power source.

In such a direct methanol fuel cell, a proton conductive solid polymer membrane is employed as an electrolytic membrane, and a cathode constituted by porous carbon paper coated functioning as a diffusion layer on which a catalyst is coated and an anode are connected through the electrolytic membrane, and an anode side separator having a groove for flowing methanol as the fuel is provided on the anode side and a cathode side separator having a groove for supplying air as oxidant gas is provided on the cathode side.

When methanol aqueous solution is supplied to the anode and air is supplied to the cathode, carbon dioxide gas is formed and hydrogen ions and electrons are released at the anode by oxidation reaction of methanol and water (CH₃0H+H₂O→CO₂+6H⁺+6e⁻), and water is formed at the anode by reduction reaction of the hydrogen ion passed through the electrolytic membrane (6H⁺+(3/2)O₂+6e⁻→3H₂O). Electric energy can be output to an external circuit by connecting with the cathode and the anode. Therefore, the entire reaction in the direct methanol fuel cell is reaction of forming water and carbon dioxide from methanol and oxygen.

Air is usually employed for the oxidant for the fuel. On the other hand, the fuel cell include one employing hydrogen ions obtained by reaction water with natural gas or methanol as the fuel and one employing hydrogen ions directly formed from hydrogen gas. These cells either caused a problem that flammable gas is employed, and diligently devising on the storing method for the fuel has been performed.

In the case of hydrogen gas, a method of storing hydrogen in a state of gas in a high pressure gas bomb is applied. However, such method of storing the high pressure gas requires a thick container even though the method is simple. Therefore, the efficiency of the store and conveyance are low and difficultly applied, for example, for cars and mobile information instruments for which the light weight of the cell system is important. When hydrogen is stored in a liquid state, the storing and conveying efficiency are raised. However, economical problems are posed such as that highly purified hydrogen is necessary for preparing liquid hydrogen and a special container for extreme low temperature since the liquefaction temperature is extremely low as −252.6° C.

Though it has been also proposed to use of a hydrogen storing alloy, there are problems that the hydrogen storing alloy is heavy and light weight hydrogen storing magnesium alloy requires a high temperature of about 300° C. for releasing hydrogen. Moreover, use of a porous carbon material such as a carbon nano-tube has been proposed. However, many problems are caused such as that the reproducibility of hydrogen storing ability is low and the storing has to be performed under high pressured condition.

For solving such problems, Patent Document 1 proposes to use a hydrogen molecule inclusion compound in which hydrogen molecule is included by catalytic reaction of a host compound and hydrogen molecule. This technique has a problem on the safeness such as that hydrogen gas fuel is released at a relatively low temperature of 50° C., slightly higher than the room temperature, and a lot of the inclusion compound is necessary for including hydrogen gas. The method in which the fuel hydrogen gas is physically adsorbed to the host molecule by weak interaction without bonding has a technical limitation on the downsizing of the apparatus for safety transporting the fuel.

Research and develop to use a liquid fuel such as alcohol other than the gas fuel is actively progressed. As the liquid fuel cell, various types such as a vaporized fuel supplying type and a capillary phenomenon utilizing type are known. Usual vaporized fuel supplying type is advantageous for downsizing the fuel section. However, the system is complicated and downsizing without changing the constitution is difficult, and a problem is posed-from the viewpoint of the safety transportation since the flammable liquid fuel is employed.

On the other hand, the usual liquid fuel cell has to use low concentration fuel since the liquid fuel is directly supplied to the fuel electrode even though the structure thereof is suitable for downsizing. Consequently, the volume of the fuel section becomes larger and the entire system is difficultly downsized. For avoiding such problem, a method can be considered in which the fuel is separated into high concentration fuel and diluting liquid and both of them are mixed on the occasion of the use. However, the problem is leaved from viewpoint of the safety transportation since the flammable liquid fuel is employed.

Patent Document 1: JP-A No. 2004-119276

### SUMMARY OF THE INVENTION

As above-mentioned, the problem of the form of the fuel is a very important subject for downsizing and making practicable the fuel cell as the power source of a small size instrument.

In the technique disclosed in Patent Document 1, the storage and transportation efficiency are improved by converting hydrogen gas as the fuel to a hydrogen molecule inclusion compound. However, the foregoing problems are leaved in this technique.

The present invention may provide a fuel supplying system suitable for a downsized fuel cell useful for a small size instrument by solving the problem of the form of the fuel and that caused by the method in which hydrogen gas is physically adsorbed by the host molecule by the weak interaction. An embodiment of the invention is to provide a fuel supplying system suitable for a downsized fuel cell and a fuel cell with high reliability and stability in the output power employing the fuel.

The above embodiment can be attained by the following structures.

(1) An aspect of the present invention includes a fuel supplying system for a fuel cell, comprising a container having therein a liquid fuel and a carrier for fixing the liquid fuel,

wherein the carrier contains solid particles having an average particle diameter of 0.1 μm to 5 mm.

(2) Another aspect of the present invention includes a fuel supplying system of the above-described item 1,

wherein the carrier is a material having a weight-average molecular weight of not less than 100.

(3) Another aspect of the present invention includes a fuel supplying system of the above-described item 1,

wherein the liquid fuel is released by introducing a second liquid into the container so as to contact with the carrier which fixes the liquid fuel, provided that the second liquid has a larger chemical affinity to the carrier than the liquid fuel.

(4) Another aspect of the present invention includes a fuel supplying system of the above-described item 3,

wherein the carrier is contained in a membrane through which the liquid fuel and the second liquid penetrate.

(5) Another aspect of the present invention includes a fuel cell employing the fuel supplying system of the above-described item 1.

The fuel supplying system for a fuel cell according to an embodiment of the invention contains a carrier for fixing the liquid fuel in a state capable of releasing the liquid fuel on the occasion of functioning as the fuel for the fuel cell. Therefore, the fuel has a large advantage that it can be safety handled until functioning as the fuel for the fuel cell since the liquid fuel is fixed by the carrier.

The liquid fuel is released by only contacting the carrier fixing the liquid fuel with another liquid having chemical affinity to the carrier larger than that of the liquid fuel when the fuel functions as the fuel for the fuel cell. Accordingly, the fuel cell with high reliability and stability in the output power can be obtained by the use of the fuel supplying system for a fuel cell according to an embodiment of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a schematic drawing of a fuel cell to which the fuel supplying system for a fuel cell according to an embodiment of the invention is applied.

FIG. 2 shows a cross section of a cell unit of the fuel cell according to an embodiment of the invention.

### DESCRIPTION OF THE PREFERRED EMBODIMENTS

The fuel supplying system for a fuel cell according to an embodiment of the invention is detailed below.

The fuel supplying system for a fuel cell relating to the invention contains the carrier for fixing the liquid fuel in the state capable of releasing the liquid fuel on the occasion of the fuel functions as the fuel of a fuel cell.

Any liquid fuel capable of being employed for the fuel cell described in, for example, T. Takahashi “Nenryou denchi (Fuel cell)”, Kyoritsu Shuppan Co., Ltd., can be used for the liquid fuel on the occasion of functioning as the fuel supplying system for a fuel cell according to an embodiment of the invention. Compounds are preferable which have a functional group or a bonding group each capable of forming a hydrogen bond such as a hydroxyl group, an amino group, an amine and an ether bond. In concrete, an alcohol such as methanol and ethanol, ether such as diethyl ether, and hydrazine are employable. In the invention, an alcohol having a hydroxyl group is preferable and methanol is particularly preferable.

The liquid fuel according to an embodiment of the invention is essentially different from gas fuel such as hydrogen gas having no functional group other than the property of gas state, and the liquid fuel fixed by the carrier is not spontaneously released on the than the occasion of functioning as the fuel supplying system for a fuel cell.

For fixing the liquid fuel by the carrier, a method can be applied in which the liquid fuel is fixed at a room temperature by a solid inorganic or organic compound. A method utilizing chemical adsorption forming a hydrogen bond, an ester bond or a coordinate bond or a method utilizing physical adsorption by van der Waals force or electrostatic force can be applied for the fixation. Fixing by utilizing the chemical adsorption force or both of the chemical and physical adsorption forces is preferable for safety handling. However, the form of the fixing is not specifically limited as long as the fixing is carried out by a method for forming the liquid fuel which is not released to air when the fixed material is leaved intact at the room temperature. In the invention, the room temperature is generally from 10° C. to 40° C. though it cannot be unconditionally defined since it is varied depending on the area and season.

Any compound capable of reversibly adsorbing and desorbing the molecules of the fuel can be employed as the carrier for the liquid fuel, and inorganic compounds and organic compounds each of which is solid at the room temperature are employable.

As the inorganic compound which is solid at the room temperature, a compound having a porous structure such as an aggregate of a nano-size particle and a planer particle is preferable. For example, a clayey mineral such as montmorillonite having a layered structure which can stably fix the molecules between the layers. A compound having the porous structure such as zeolite and an ultra fine particle of metal oxide are preferable substance in the invention because they have a large surface area and can adsorb a large amount of the liquid fuel. Other than the above, compounds disclosed in, for example, “Takoushitu-tai no Seishitu to Sono Ouyou Gijutus (Properties of Porous substance and its Application)” edited by Y. Takeuch, Fuji Technosystem Co., Ltd., and “Yuuki-Muki Hybrid Zairyou no Kaihatsu to Ouyou (Development and Application of Inorganic-Organic Hybrid Material)” edited by M. Kajiwara, CMC Co., Ltd., are employable.

As the organic compound which is solid at the room temperature, the following compounds can be cited which are described in “Bunshi Shugo-tai, sono Soshikika to Kinou (Molecule aggregate and their Organization and Function)” Kagaku Sosetu 40 edited by Nihon Kagaku Kai (The Chemical Society of Japan): A group of compounds having the inclusion ability such as a crown tether, a cryptand, a cyclophane, an azacyclophane, a calixarene, a cyclotribelatolylene, a spherand, a urea and a thiourea, and a compound having the inclusion ability or the molecule adsorption ability such as a cyclodextrin, a cyclic oligopeptide, a deoxycholic acid, a perhydrotriphenylene, a tri-o-thymotide, a bianthryl, a spirobufluorene, a cyclophosphazene, a monoalcohol, a diol, an acetylene alcohol, a hydroxybenzophenone, a phenol, a bisphenol, a trisphenol, a tetrakisphenol, a polyphenol, a naphthol, a bisnaphthol, a diphenylmethanol, a carboxylic amido, a thioamide, a bixanthene, a carboxylic acid, an imidazole, a hydroquinone, a cellulose, a starch, a chitin, a chitosan, a poly(vinyl alcohol), a polyether polyol, a polyethylene glycol arm type polymer having a core of 1,1,2,2-tetrakisphenylethane, a polyethylene glycol arm type polymer having a core of α,α,α′,α′-tetrakisphenyl-xylene, 1,1,6,6-tetraphenyl-2,4-hexadiine-1,6-diol, 1,1-bis(2,4-dimethylphenyl)-2-propine-1-ol, 1,1,4,4-tetraphenyl-2-butine-1,4-diol, 1,1,6,6-tetrakis(2,4-dimethylphenyl)-2,4-hexadiine-1,6-diol, 9,10-diphenyl-9,10,-dihydroanthrathene-9,10-diol, 9,10-bis(4-methylphenyl)-9,10-dihydroanthrathene-9,10-diol,1,1,2,2-tetraphenylethane-1,2-diol, 4-methoxyphenol, 2,4-dihydroxybenzophenone, 4,4′-dihydroxybenzophenone, 2,2′-hydroxybenzophenone, 2,2′,4,4′-tetrahydroxy-benzophenone, 1,1-bis(4-hydroxylphenyl)cyclohexane, 4,4′-sulfonylbisphenol, 2,2′-methylenebis(4-methyl-6-t-butylphenol), 4,4′-ethylidenebisphenol, 4,4′-thiobis(3-methyl-6-t-butylphenol), 1,1,3-tris(2-methyl-4-hydroxy-5-t-butylphenyl)butane, 1,1,2,2-tetrakis(hydroxyphenyl)ethane, 1,1,2,2-tetrakis(3-methyl-4-hydroxyphenyl)ethane, 1,1,2,2-tetrakis(3-fluoro-4-hydroxyphenyl)ethane, α,α,α′,α′-tetrakis((4-hydroxyphenyl)-p-xylene, 3,6,3′,6′-tetramethoxy-9,9′-bi-9H-xanthene, 3,6,3′,6′-tetraacetoxy-9,9′-bi-9H-xanthene, 3,6,3′,6′-tetrahydroxy-9,9′-bi-9H-xanthene, gallic acid, methyl gallate, cathechin, bis-β-naphthol, α,α,α,α′-tetraphenyl-1,1′-biphenyl-2,2′-dimethanol, diphenylic bisdicyclohexylamide, fumalic bisdicyclohexylamide, cholic acid, deoxycholic acid, 1,1,2,2-terakis(4-carboxyphenyl)ethane, 1,1,2,2-terakis(3-carboxyphenyl)ethane, 2,4,5-triphenylimidazole, 2-t-butylhydroquinone, 2,5-di-t-butylhydroquinone, and 2,5-bis(2,4-dimethylphenyl)hydroquinone.

Among the above, the compounds having a weight average molecular weight of not less than 100 are preferable in the invention since the compound can be separated and recovered by the use of a semipermeable membrane on the occasion of releasing the liquid fuel. One having a weight average molecular weight of not less than 300 is more preferable, which can be more easily separated and recovered. Though the upper limit of the weight average molecular weight is not provided, a weight average molecular weight is not more than one hundred million, preferably not more than 10,000,000, and more preferably not more than 5,000,000, from the viewpoint of adsorption of the liquid fuel with high efficiency.

Particularly preferable compound for the carrier of the liquid fuel relating to the invention is a cyclodextrin having a functional group capable of forming a hydrogen bond with the liquid fuel having a hydroxyl group. The cyclodextrin may include either a cyclodextrin or a branched cyclodextrin. Examples of the cyclodextrin include α-cyclodextrin, β-cyclodextrin, γ-cyclodextrin, and cyclic tetrose described in Tokkai 2003-235596. β-cyclodextrin is preferred.

The branched cyclodextrin is a cyclodextrin having a branch of glutose or maltose, for examples, a glucosyl-cyclodextrin bonded with one glutose molecule, such as G1-β-cyclodextrin and G1-γ-cyclodextrin a maltosylcyclodextrin bonded with maltose composed of two glucose molecules such as G2-α-cyclodextrin such as G2-α-cyclodextrin, G2-β-cyclodextrin and G2-γ-cyclodextrin, a cyclodextrin bonding with malttriose composed of three glucose molecules such as G3-α-cyclodextrin, G3-β-cyclodextrin and G3-γ-cyclodextrin, and a maltotriosylcyclodextrin in which a maltotriosyl groups are bonded at two or more positions of a cyclodextrin such as G1-G1-, C1-G2- and G2-G2-cyclodextrine. Glucosylcyclodextrin and maltosylcyclodextrin are preferable.

Other than the above, any dextrin having a size of from 4 to 12 angstroms, and preferable from 6 to 10 angstrom, capable of including a tetrahydrothiophene-1,1-dioxide derivative can be employed. A mixture of them may be employable. β-cyclodextrin with relatively low cost is advantageous for industrial use.

A typical method for fixing the liquid fuel to the carrier is described referring an example using cyclodextrin. The following method usually used for producing an inclusion compound can be applied but the method is not limited to the followings.

1) Saturated Aqueous Solution Method

A saturated solution of cyclodextrin is prepared, and the liquid fuel or its solution in a suitable solvent such as ethanol and acetone is mixed with the saturated cyclodextrin solution, and then vigorously stirred for a time of from 0.5 to several hours. Thus an inclusion compound is precipitated in a solid state. The inclusion compound to be employed as the fuel for the fuel cell can be obtained by filtering and drying the precipitation.

2) Kneading Method

A small amount (usually 0.3 to 5 times) of water is added to cyclodextrin and kneaded, and then the liquid fuel or its solution in an optional solvent is added and sufficiently kneaded. The inclusion compound of the liquid fuel is formed by kneading usually for a time of from 0.5 to several hours. The ratio of the liquid fuel to cyclodextrin is from 1:1 to 1:100, preferably from 1:1 to 1:9, and more preferably from 1:1 to 1:6.

When an alcohol such as methanol is employed as the liquid fuel, the solidification of the liquid fuel can be carried out by kneading the solid organic compound and the alcohol in an optional ratio at the room temperature. The mixing ratio of the alcohol and the organic compound in solid state at the room temperature is decided according to the property of the mixture. When the mixture is liquid state at the room temperature, the mixing ratio is unsuitable for the purpose of the invention. The mixing ratio by which the state of the mixture is made to solid or gel at the room temperature is suitable ratio for the fuel supplying system for a fuel cell of the invention. In other words, the fuel which is not liquid at the room temperature is the fuel supplying system for a fuel cell according to an embodiment of the invention. The liquid is a substance having fluidity, and one having a viscosity of not more than 0.5 Pa.s at 30° C. can be visibly distinguished as the liquid. The viscosity is measured by ARES viscoelastometer manufactured by Leometric Scientific F. E. Co., Ltd.

The liquid fuel fixed by the carrier is released by contacting another liquid (also called as “a second liquid”) having larger chemical affinity to the carrier than that of the liquid fuel. The liquid other than the fuel is preferably water.

The liquid fuel fixed by the carrier may be employed in a state of powdered or formed for fitting to the shape of a container for convenience though the fixed fuel may be employed in the intact shape. The shape of the liquid fuel fixed by the carrier is freely decided without any limitation.

When the fixed fuel is employed in a form of powered, the average particle diameter is preferably not less than 0.1 μm; excessively small size of the particle causes difficulty for the handling. An average particle sized of not less than 0.5 μm is more preferable and an average diameter of not less than 1 μm is suitable since extreme fine particles easily floating in air are reduced. Though a large average particle diameter does not cause any inconvenience, an average particle diameter not more than 5 mm is preferable considering the granulation process of the powder and an average diameter of not more than 1 mm is more suitable. The distribution of the particle size is insignificant, and the presence of a particle having a diameter larger than 100 times of the average particle diameter is arrowed.

A method is convenience in which the carrier fixing the liquid fuel is put into the fuel container of a fuel cell in a form of packed by film or contained in a container. In the invention, there is no limitation on the post-treatment to the carrier fixing the fuel. For example, a method in which the carrier fixing the fuel is packed by film permeable another liquid having larger affinity to the carrier than that of the fuel is convenience because the liquid fuel can be separated from the carrier or the compound by which the liquid fuel has been fixed. It is more suitable that the film is a membrane capable of selectively permeating the liquid fuel and water. A semipermeable membrane such as cellulose film is further preferable.

The fuel supplying system for a fuel cell according to an embodiment of the invention can release the liquid fuel by only contacting the carrier fixing the liquid fuel to the other liquid such as water having larger affinity. Consequently, the fuel supplying system for a fuel cell according to an embodiment of the invention can be easily handled in the distribution course from the production to the use and can be safely transported.

The fuel cell to which the fuel supplying system for a fuel cell according to an embodiment of the invention is applied is described below referring the drawings.

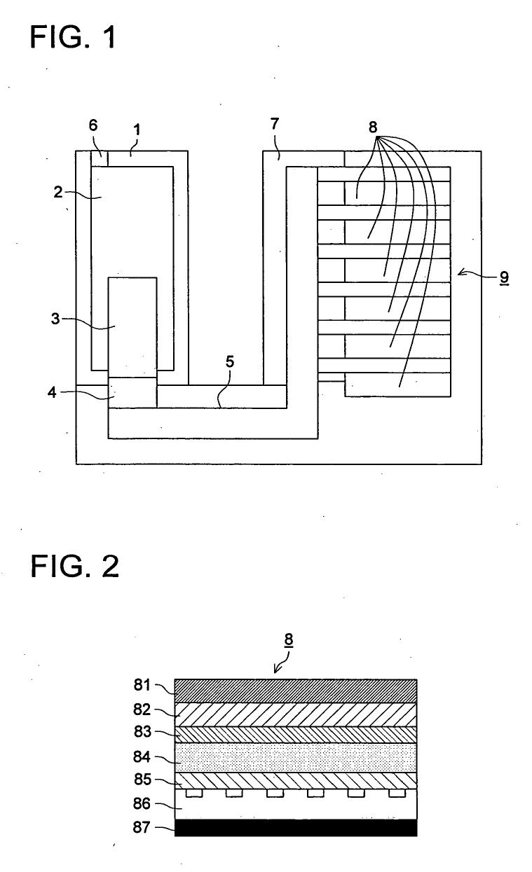

The fuel cell shown in FIG. 1 is basically constituted by a liquid fuel taking container 1 for taking a mixture 2 (simply referred to as a fuel) of the fuel supplying system for a fuel cell and the other liquid having larger affinity such as water, a fuel cell stack 9, and a fuel introducing tube 5 for introducing the liquid fuel, concretely a mixture of methanol and water (hereinafter referred to as the liquid fuel in the description of the drawings) released from the fuel supplying system for a fuel cell according to an embodiment of the invention from the liquid fuel taking container 1 to the fuel cell stack 9. A ventilation mechanism, not shown in the drawing, such as a fun is usually provided for supplying the oxidant gas. The fuel cell stack 9 shown in the drawing is constituted by a stack of a plurality of a unit cell 8 having an electric power generator containing a fuel electrode, an oxidant electrode, and an electrolytic plate placed between the electrodes. The unit cell 8 may be singly used without stacking.

FIG. 2 shows an example of the constitution of the unit cell 8. As is shown in the drawing, the unit cell 8 is constituted by an vaporizing plate 82, an anode or fuel electrode 83, an electrolytic membrane 84, a cathode or oxidant electrode 85 and a gas channel 86 arranged between a liquid permeating plate 81 and a separator 87.

In FIG. 1, the introducing tube 5 can be constituted by a fine tube in which a capillary phenomenon is effective. The introducing tube 5 may be filled by a porous material capable of permeating the liquid fuel for assisting the introduction of the fuel. As the fuel permeable material, for example, a porous material such as a sponge of polyurethane, polyester, cellulose or phenol type resin is usable.

As is shown in the drawing, in the fuel cell of the invention, the fuel taking container 1 is connected to the introducing tube at a connecting device, and it is desired that the connecting device is tightly sealed. Risk of vaporization of the liquid fuel is caused when the seal of the connecting device is insufficient.

The liquid fuel 2 introduced into the fuel cell stack 9 by the introducing tube 5 is conducted to a liquid fuel holding material so called receiver 7 through a molecular filtering membrane 3 for uniformly and stably supplying to each unit cells 8 in the cell stack. The liquid fuel is supplied to each of the unit cells 8 through the receiver 7 and vaporized in a vaporizing section provided before the fuel electrode and introduced to the fuel electrode.

In the fuel cell according to an embodiment of the invention, any driving means such as a pump for supplying the fuel is not necessary because the liquid fuel is introduced into the fuel cell stack 9 by the capillary phenomenon. The liquid fuel introduced into the cell is vaporized at a fuel evaporating membrane by utilizing reaction heat generated by the cell reaction. Therefore, any supplemental device such as a fuel vaporizing device is not necessary. Moreover, the fuel vapor in the fuel vaporizing membrane is held in almost saturated state, accordingly, the liquid fuel is vaporized from the fuel permeable membrane in an amount the same as the consumed amount of the fuel in the fuel vaporizing membrane by the cell reaction and the liquid fuel in an amount the same as the vaporized amount is introduced into the fuel cell stack 9 by the capillary phenomenon.

Moreover, in the fuel cell of the invention, almost no unreacted liquid fuel is exhausted from the cell because the supplying amount of the fuel is linked with the fuel consuming amount. Therefore, any treatment system is not necessary at the fuel exhausting side. In the fuel cell of the invention, the liquid fuel can be smoothly supplied without use of any supplemental devices such as a pump, blower, fuel vaporizer and condenser. Thus the fuel cell can be made compact.

In the liquid fuel taking container 1, a mechanism capable of controlling the inner pressure is provided for stably supplying the liquid fuel to the fuel vaporizing membrane. A mechanism for flowing out the liquid fuel without delay from the liquid fuel taking container 1 corresponding to the consumption of fuel at the vaporizing membrane. For example, an anti negative pressure mechanism by taking in air from the exterior accompanied with the flowing out of the liquid fuel from the container. By means of such mechanism, the pressure in the container can be controlled so that the pressure in the container is not made lower than that in the main body. In concrete, a pressure controlling hole 6 provided at the designated area on the upper side of the liquid fuel taking container 1 can be applied as the countermeasure to the negative pressure. The pressure controlling hole 6 is not limited to one; several holes may be provided. Though the size of the hole is not specifically limited, a size of from 0.5 to 5 mm is preferred for preventing the excessive vaporization of the liquid fuel.

A selectively permeable membrane can be provided to the pressure controlling hole 6. For the selectively permeable membrane, one having low permeability for the vapor of the liquid fuel component and relatively high permeability for a gas such as air is preferably employed. As the selectively permeable membrane, for example, a fluorine-containing FEP resin (a copolymer of tetrafluoroethylene and hexafluoropropylene) is employable. The thickness of the selectively permeable membrane can be optionally selected corresponding to the kind, composition and saturated vapor pressure of the liquid fuel to be employed, and is usually from 10 to 1,000 μm.

### EXAMPLES

The invention is concretely described referring examples of a direct methanol fuel cell (DMFC).

### Example 1

Each 80 g of powder of cyclodextrin (Commercial name: Celdex A-100, manufactured by Nihon Shokuhin Kako Co., Ltd.), cyclodextrin (Commercial name: Celdex B-100, manufactured by Nihon Shokuhin Kako Co., Ltd.) and cyclodextrin (Commercial name: Celdex G-100, manufactured by Nihon Shokuhin Kako Co., Ltd.) were dissolved in 6,000 g of warm water of 85° C. To the solution of 3 kinds of cyclodextrin, was added 1,000 g of methanol and the resultant mixture was stirred and concentrated for 24 hours at 50° C. After that 1,000 g of methanol was further added at 50° C. and then heating was stopped and the mixture was stirred for 24 hours so as to be cooled by the room temperature. The mixture was dried by spraying by nitrogen gas under a chamber temperature of 50° C. using an anti-explosion type spray drying machine. Thus 300 g of a powder was obtained. In 100 ml of warm water of 50° C., 1 g of the powder was dissolved and cooled. The methanol content was measured by a gas chromatography. As a result of that, it was confirmed that 0.25 g of methanol was fixed per gram of the powder. The average particle diameter of the powder was 0.8 μm.

In this example, a material containing not less than 25% by weight of liquid fuel for the DMFC was produced, and a methanol-water mixture containing 25% by weight of methanol was obtained by adding water. The resultant liquid could be employed as the fuel of the DMCF.

### Example 2

In a mortar, 100 g of β-dextrin (Celdex N) and 100 g of water was mixed to make surely. To the surely, 30 g of methanol was added and sufficiently kneaded. The viscosity was rapidly raised by continuing the kneading. After kneading for 2 hours, the kneaded surly was dried by air for one week. Resultant dried material was put into a polyethylene bag and powdered by beating by a plastic hummer. The amount of thus obtained powder was 120 g, and the methanol content of the powder was 30% by weight. The average particle diameter was 0.6 mm and a large particle having a diameter of 6.5 mm was also contained.

The material containing not less than 30% by weight of liquid fuel of the DMFC was prepared in this example. A mixture of methanol and water containing 30% by weight of methanol was obtained by adding water, and the mixture could be employed as the fuel for the MDFC.

Operation 1 of Fuel Cell

Preparation of Fuel Cell

A unit cell in the fuel cell stack was prepared by the following procedure.

A fuel electrode of 32 mm×32 mm formed by coating a Pt—Ru catalyst layer on carbon cloth and an oxidant electrode of 32 mm×32 mm formed by coating a Pt black catalyst layer on carbon cloth were prepared. An electrolytic membrane composed of a perfluorosulfonic acid layer was placed between the fuel electrode and the oxidant electrode so that catalyst layer of the fuel electrode and that of the oxidant electrode were each contacted to the electrolytic membrane. The resultant block was united by hot-press with a pressure of 100 kg/cm² at 120° C. for 5 minutes to prepare an electricity generation element.

The electricity generation element was laminated with a porous carbon plate having an average pore diameter of 85 μm and a porosity of 73% as a fuel vaporizing layer and a porous carbon plate having an average pore diameter of 5 μm and a porosity of 40% as a fuel permeable layer. The resultant matter was arranged between an oxidant electrode side holder and a fuel electrode side holder to prepare a unit cell having a reaction area of 10 cm². On the oxidant electrode side holder, an oxidant gas supplying groove having a deepness of 2 mm and a width of 1 mm was provided.

Ten unit cells each having thus described constitution were stacked to obtain a fuel cell.

Operation of Fuel Cell 1

Three hundreds grams of fuel powder prepared in Example 1 which contains not less than 25% by weight of liquid fuel for DMFC and packed with cellulose film and 90 g of water were put into the liquid fuel taking container 1. A pressure controlling hole 6 having a diameter of 5 mm as the anti-negative pressure mechanism was provided at the position shown in FIG. 1. The liquid fuel taking container was set at the connecting section 4 as shown in FIG. 1. In FIG. 1, the liquid fuel 2 in the liquid fuel taking container 1 is supplied to the fuel electrode side by capillary phenomenon through the introducing tube 5, the molecular filtering membrane, the porous carbon plate in this case, and the receiver 7.

Power generation was performed employing the above fuel cell at 80° C. while flowing 100 ml/minute at 1 atm of air as the oxidant gas through the gas channel 76.

As a result of that, electric power of 280 mA/cm² at 3.8 V can be output. The output was stable without lowering when the electricity generation was continued for 10 hours. The liquid fuel (methanol-water mixture) was not leaked not only during the operation of the fuel cell but on the occasion of install and remove of the fuel container. Accordingly, it was confirmed that the fuel cell was a compact and highly reliable fuel cell.

Operation 2 of Fuel Cell

A fuel cell the same as that in the operation 1 was prepared and electricity generation was performed in the same manner as in the operation 1 except that the fuel powder containing not less than 30% by weight of the liquid fuel for DMFC prepared in Example 2 was employed for the fuel to be put into the liquid fuel taking container 1.

As a result of that, electric power of 280 mA/cm² at 4.2 V can be output. The output was stable without lowering when the electricity generation was continued for 10 hours. The liquid fuel (methanol-water mixture) was not leaked not only during the operation of the fuel cell but on the occasion of install and remove of the fuel container. Accordingly, it was confirmed that the fuel cell was a compact and highly reliable fuel cell.

While the preferred embodiments of the present invention have been described using specific terms, such description is for illustrative purposes only, and it is to be understood that changes and variations may be made without departing from the spirit or scope of the appended claims.

What is claimed is:

1. A fuel supplying system for a fuel cell, comprising a container having therein a liquid fuel and a carrier for fixing the liquid fuel,
wherein the carrier contains solid particles having an average particle diameter of 0.1 μm to 5 mm.

2. The fuel supplying system of claim 1,
wherein the carrier is a material having a weight-average molecular weight of not less than 100.

3. The fuel supplying system of claim 1,
wherein the liquid fuel is released by introducing a second liquid into the container so as to contact with the carrier which fixes the liquid fuel, provided that the second liquid has a larger chemical affinity to the carrier than the liquid fuel.

4. The fuel supplying system of claim 3,
wherein the carrier is contained in a membrane through which the liquid fuel and the second liquid penetrate.

5. A fuel cell employing the fuel supplying system of claim 1.
